(19) United States
(12) Patent Application Publication
(10) Pub. No.: US 2024/0195812 A1
(43) Pub. Date: Jun. 13, 2024

(54) Onboarding Auto Creation of UDN Groups and Dynamic Binding

(71) Applicant: Cisco Technology, Inc., San Jose, CA (US)

(72) Inventors: Shree Narasimha Murthy, San Jose, CA (US); Arun G Khanna, Sunnyvale, CA (US); Sri Gundavelli, San Jose, CA (US)

(21) Appl. No.: 18/062,967

(22) Filed: Dec. 7, 2022

(51) Int. Cl. H04L 9/40; H04L 67/12

(52) U.S. Cl. CPC H04L 63/104; H04L 63/08; H04L 67/12

(57) ABSTRACT

Disclosed herein are systems, methods, and computer-readable media for dynamic user device access to a user defined network (UDN) group. A request from a user device to access an end device is received from an application on the user device, where the request includes a credential and the end device is associated with multiple end devices within a private group with access to a set of services. A user device identity of the user device is dynamically added to the private group (e.g., UDN group) based on authenticating the user device based on the credential being associated with the private group. A change of authorization is sent to a controller to include the user device within the private group, and the user device is granted access to the set of services.

### TECHNICAL FIELD

The subject matter of this disclosure relates in general to the field of computer networking, and more particularly, to the creation and implementation of user defined networks (UDNs).

### BACKGROUND

Multiple problems arise when connecting all of the user's devices to a shared network environment such as hotel rooms, hospital rooms, dorm rooms, classrooms, multi-dwelling building units, etc. For example, there may be too many users/devices on the shared network and onboarding of devices is not secure. In addition, there is limited user control; that is, there is no easy way for the users to deterministically discover and limit access to only the devices that belong to them. A user can see all users' devices and every user can see their device. This not only results in poor user experience but also brings in security concerns where users knowingly or unknowingly can take control of devices that may belong to other users.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example user defined network (UDN) system, according to some aspects of the present disclosure.

FIG. 2 illustrates an example method for implementing one or more UDNs within a same physical space, according to some aspects of the present disclosure.

FIG. 3 illustrates an example communication diagram for implementing one or more UDNs within the same physical space, according to some aspects of the present disclosure.

FIG. 4 shows an example of computing system 400, which can be for example any computing device that can implement components of the system

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

The present disclosure is directed to techniques for allowing a user device access to a user defined network (UDN) group dynamically without having to explicitly join the UDN group.

In one aspect, a method can include receiving, from an application on a user device, a request from the user device to access an end device, where the request includes a credential and the end device is associated with multiple end devices within a private group with access to a set of services. A user device identity of the user device is dynamically added to the private group (e.g., UDN group) based on authenticating the user device based on the credential being associated with the private group. A change of authorization is sent to a controller to include the user device within the private group, and the user device is granted access to the set of services.

In another aspect, the private group is logically associated with multiple end devices within a room.

In another aspect, two or more private groups are associated with a same physical space.

In another aspect, the user device is dynamically removed from the private group based on removing the user device identity. A second user device identity of a second user device is dynamically mapped to the private group, and a change of authorization to include the second user device within the private group is sent to the controller.

In another aspect, the multiple end devices are registered to the private group. In response to registering the multiple end devices, one or more policies associated with the private group are created.

In another aspect, the multiple end devices are unilateral devices that cannot communicate with devices outside the private group.

In another aspect, a guest for a room is assigned to the private group by associating the user device with a specific access point device.

In another aspect, co-location of the user device to an access point is determined. The co-location of the user device is validated to the private group based on detecting the access point. A change of authorization to include the user device within the private group based on the co-location of the user device to the private group is sent to the controller, and access of the user device to other private groups associated with geolocations outside of the private group is restricted.

In another aspect, the private group is assigned to be a dynamic UDN group, where member devices of the UDN group are configured to be appended or removed on an at-will basis.

In another aspect, the number of member devices within the private group is limited.

In another aspect, the user device is removed from the private group.

In one aspect, a computing apparatus includes a processor and a memory storing instructions that, when executed by the processor, configure the apparatus to receive, from an application on a user device, a request from the user device to access an end device, where the request includes a credential and the end device is associated with multiple end devices within a private group with access to a set of services. A user device identity of the user device is dynamically added to the private group (e.g., UDN group) based on authenticating the user device based on the credential being associated with the private group. A change of authorization is sent to a controller to include the user device within the private group, and the user device is granted access to the set of services.

In another aspect, the private group is logically associated with multiple end devices within a room.

In another aspect, two or more private groups are associated with a same physical space.

In another aspect, the user device is dynamically removed from the private group based on removing the user device identity. A second user device identity of a second user device is dynamically mapped to the private group, and a change of authorization to include the second user device within the private group is sent to the controller.

In another aspect, the multiple end devices are registered to the private group. In response to registering the multiple end devices, one or more policies associated with the private group are created.

In one aspect, a non-transitory computer-readable storage medium, the computer-readable storage medium including instructions that when executed by a computer, cause the computer to receive, from an application on a user device, a request from the user device to access an end device, where the request includes a credential and the end device is associated with multiple end devices within a private group with access to a set of services. A user device identity of the user device is dynamically added to the private group (e.g., UDN group) based on authenticating the user device based on the credential being associated with the private group. A change of authorization is sent to a controller to include the user device within the private group, and the user device is granted access to the set of services.

In another aspect, the private group is logically associated with multiple end devices within a room.

In another aspect, two or more private groups are associated with a same physical space.

In another aspect, the user device is dynamically removed from the private group based on removing the user device identity. A second user device identity of a second user device is dynamically mapped to the private group, and a change of authorization to include the second user device within the private group is sent to the controller.

### DESCRIPTION OF EXAMPLE EMBODIMENTS

User Defined Networks (UDNs) change the shared network experience by enabling simple, secure and remote on-boarding of wireless endpoints on to the shared network to give a personal network-like experience. The creation and implementation of UDNs provide control to the end-users to create individual personal networks consisting of a set of their devices and also enables the end-users the ability to invite other trusted users into their personal network. This provides security to the users while at the same time giving them the ability to provide access to their devices with other trusted users.

The UDN can be, for example, a construct in enterprise networks defining logical private groups. UDN allows an end-user to create one or more private networks, which will limit service discovery scope, realize traffic segmentation, and enforce access controls at a private group level. It enables the creation of personal rooms based on the intent of the users. End-users are given the flexibility to add/remove their devices to the network to create their own personal room. Although this gives the power to the end-users, it is a manual process and may not fit all environments and customer deployments.

For example, one or more UDN groups for a user are created based upon user authentication into the network and a unique ID that is assigned to the group. This group can be designated, for example, UDN-ID-1. The group owner can then either statically add a set of MAC addresses to the group or can activate an invitation workflow which results in the invited user adding one or more devices into the group. This configuration is manual in nature and typically requires an application on the user's endpoint, or alternatively, the IT administrator would have to do this manually. The whole process is an involved process.

However, there are environments where the UDN group creation needs to be automatic (e.g., without user involvement). Based on business requirements, in certain use cases, it would be preferable for the end users to be part of a private room automatically. For example, in the hospitality industry, all devices in each hotel room would be part of a UDN group and the hotel guest should be allowed to access devices that belong to his/her room only based on which hotel room they are assigned to. The following systems and methods describe UDNs that enable end devices/users to be placed in a UDN group dynamically without having to explicitly join the UDN group.

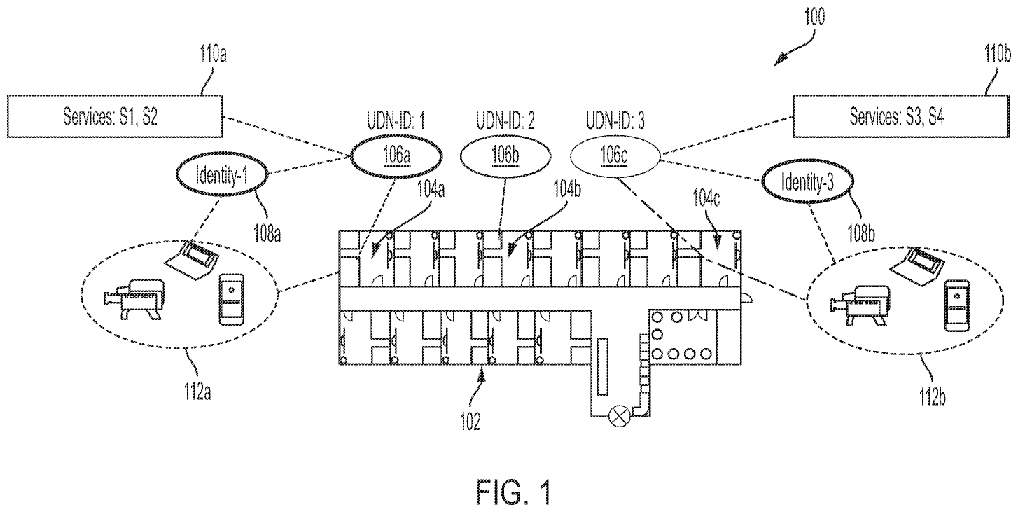

FIG. 1 illustrates an example user defined network (UDN) system 100 that allows the addition of users to a UDN group in an automatic manner without involving any manual operations. Building 102 in this example embodiment includes multiple rooms (e.g., room 104a, 104b, and 104c). One or more UDN groups can represent each room, although any logical grouping can be made that may or may not be based on physical location. For example, UDN group 106a can represent room 104a, UDN group 106b can represent room 104b, and UDN group 106c can represent room 104c. In some embodiments, each room can be uniquely represented by an identity represented as: (“I1” 108a, “I2” (not shown), “I3” 108b . . . “In”) for (UDN group 106a, UDN group 106b, UDN group 106c, UDN group 106n . . . ), respectively. Each of these identities can be mapped to unique UDN-IDs represented as: (“G1”, “G2”, “G3” . . . “Gn”). Each of the (Ix, Gx) tuples can be associated with a set of services (110a, 110b), where all the end-point devices (112a, 112b) belonging to this room/tuple are allowed to access only the set of services that are associated with the tuple.

For example, in some embodiments, UDN group 106a can be a private group created to be logically associated with multiple end devices 112a within room 104a. The end devices 112a can be any number of devices, and in some embodiments are unilateral devices that cannot communicate with devices outside the private group of UDN group 106a. In some embodiments, the number of member devices within the private group is limited—e.g., only 20 end devices 112a can be associated with UDN group 106a.

In some embodiments, the end devices 112a can be registered to UDN group 106a. In response to registering the end devices 112a, one or more policies associated with UDN group 106a can be created and/or assigned. For example, in UDN group 106a, services 110a “S1” and “S2” and their associated policies can be associated with registered end devices 112a. Similarly, services 110b “S3” and “S4” and their associated policies can be associated with registered end devices 112b for UDN group 106c. Devices not registered within the UDN group cannot access the services or policies of the group: e.g., end devices 112a cannot access services 110b “S3” or “S4”, and end devices 112b cannot access services 110a “S1” and “S2”.

In some embodiments, two or more UDN groups can be associated within the same physical space. For example, room 104a may have more than one UDN group, with each UDN group having its own end devices and services/policies associated with those end devices. This can be especially applied where users may have different access authorization or needs. For example, in a hospital setting, a healthcare professional may have access to a set of devices under a first UDN group (e.g., medical devices), but the patient may have access to a set of devices under a second UDN group (e.g., entertainment devices). In some embodiments, the devices may be the same, but the user can be associated with different UDN groups based on the services/policies they are authorized to be under—e.g., a user with high security clearance can have broad access permissions under a first UDN group within room 106a, but another user with no or low security clearance may be restricted in their access permissions under a second UDN group within room 106a.

Once UDN groups have been created, end users can be placed within a UDN group dynamically without having to explicitly join the UDN group. In other words, adding an end user to a UDN group does not require any manual operations.

For example, in some embodiments, the end user and/or end user's device has knowledge about its identity (Ix) only 13 this is analogous to a guest being assigned a room in a hotel. When the end user's device is on-boarded onto the network, as part of the onboarding process, it uses the identity (e.g., Ix) the end user is assigned to. This information can be included as part of the authentication process and is sent to the Authorization Server/Identity Services Engine (ISE). For example, the Authentication Server can maintain a mapping of the (Ix, Gx) tuples and assigns the group Gx to the end-point based on the Identity Ix of the end-point. Information about the Group (Gx) of the end-point is then sent to the wireless controller as part of change of authorization (CoA) message exchange. The group Gx is a unique UDN-ID for that group. All devices connected with credentials associated with a given identity (Room #, Ix), will be part of the same UDN Group. The network segmentation and traffic containment will then be enforced based on the assigned Gx/UDN-ID.

For example, UDN group 106a can be a predefined UDN group (with registered end devices 112a that includes a TV and PS3) with the group id: UDN-ID-1. It has the following members: UDN-ID-1: (Room-1-TV, Room-1-PS3), ($User-Room-101). Note that $User-Room-101 can be a special string which resolves into a set of Mac identities dynamically.

User John is assigned Room-101 (e.g., rom 104a) and given the room credentials (Room-101/Password). John uses these credentials on a MacBook device (e.g., “Mac-M1”) and iPhone (e.g., “Mac-M2”) for access authentication. The backend logic can dynamically add the end point identities (Mac-M1 and Mac-M2) of user John to the UDN group 106a, UDN-ID-1 (based on AAA interactions, and UDN policy definitions). The resulting UDN group 106a configuration is as follows: UDN-ID-1: (Room-1-TV, Room-1-PS3, Mac-M1, Mac-M2), $User-Room-101.

In other words, system 100 can receive, from an application on John's user device, a request from John's user device to access one of the end devices within room 104a associated with UDN group 106a. The request can include the credential associated with room 104a and the user's device is then associated with the multiple end devices 112a registered within UDN group 106a and it's set of services 110a. For example, the credential can be the device identity and can then be dynamically added to UDN group 106a after authenticating John's device. Authentication can be based on the credential being associated with UDN group 106a.

Once authentication is verified, a change of authorization can be sent to a controller to include John's user device within the private group. His user device is then granted access to the set of services under services 110a and its associated policies. This allows John's user device access to the end devices 112a with services S1 and S2 without having to explicitly join UDN group 106a.

Additionally and/or alternatively, in some embodiments a guest for a room is assigned to the UDN group by associating the user device with a specific access point device. If the device is co-located with the access point, it is appended to the UDN group. If not, access to the end devices within the UDN group is restricted.

For example, in some embodiments, the co-location of the user device to the room can be determined. For example, the access point can validate the co-location of the user device to room 104a—and its associated UDN group 106a—based on the access point detecting the user device. Once detected, a change of authorization is sent to the controller to include the user device within the UDN group based on its co-location to the private group's associated physical space. Access of the user device to other private networks associated with geolocations/physical spaces outside of the specific UDN group is restricted.

In other words, in some embodiments the auto-creation of UDN groups can be based on the devices attached to a given access point (e.g., whether the user's device can establish a connection with an access point). For example, room 104a can include a TV, PS3, and an access point (e.g., “Access-Point-101”). The predefined UDN group 106a with the group ID: UDN-ID-1 can have the following members. UDN-ID-1: (Room-1-TV, Room-1-PS3), ($Access-Point-101). (Note that Access-Point-101 can be a special string which resolves into a set of Mac identities that are attached to Access-Point-101).

John is assigned to Room-101 and given the room credentials (Room-101/Password). John uses these room credentials on a MacBook device (e.g., “Mac-M1”) and a mobile device (e.g., “Mac-M2”) for access authentication and attached access point (e.g., “Access-Point-101”). Based on AAA interactions and UDN policy definitions, the Mac-M1 and Mac-M2 is dynamically added/appended to the UDN group, “UDN-ID-1”.

The resulting UDN configuration is as follows: UDN-ID-1: (Room-1-TV, Room-1-PS3, Mac-M1, Mac-M2), $Access-Point-101. In other words, once authentication is verified, a change of authorization can be sent to a controller to include John's user device within the private group. His user device is then granted access to the set of services under services 110a and its associated policies. This allows John's user device access to the end devices 112a with services S1 and S2 without having to explicitly join UDN group 106a. This approach does not require any manual operations. Moreover, a user with user identity Room-102, even if he is attached to Access-Point-101, will not be part of UDN group 106a.

Additionally and/or alternatively, the user device can be removed from the private group. For example, UDN group 106a can be assigned as a dynamic UDN group, where member devices of the UDN group (e.g., end devices 112a) are configured to be appended or removed on an at-will basis. This can be done, for example, via tagging the UDN group ID that specifies the UDN group as one that allows and revokes the access of certain devices.

This can allow system 100 to dynamically update who has access to each room. For example, this can apply towards different hotel guests that occupy the same room at different times. For example, say John checks into the hotel and is assigned room 104a. He will be dynamically added to UDN group 106a on an automatic basis as disclosed in the embodiments above. At the end of his stay, system 100 will dynamically remove John's user device from UDN group 106a based on removing the John's user device identity (e.g., removing the room credentials [Room-101/Password]). Mary, a second hotel guest, is scheduled and/or checks into the hotel after John. Mary is assigned to room 104a, and dynamically added to UDN group 106a on an automatic basis as disclosed in the embodiments above (e.g., [Room-101/Password2]). Once authentication is verified, a change of authorization can be sent to a controller to include Mary's user device within UDN group 106a.

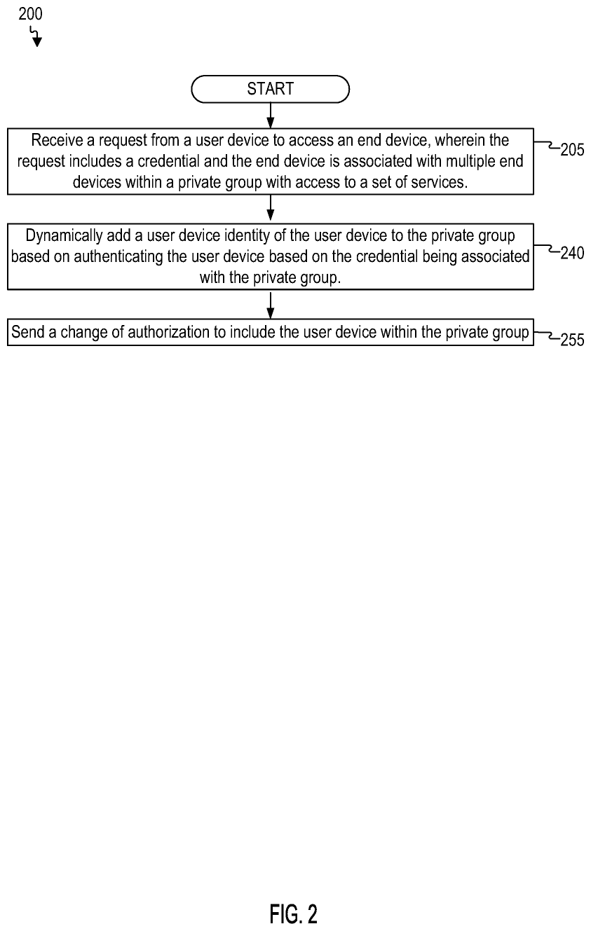

FIG. 2 illustrates an example method 200 for dynamically adding a user device to a private UDN group without having to explicitly join the UDN group. Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

According to some examples, the method includes receiving a request from a user device to access an end device, where the request includes a credential and the end device is associated with multiple end devices within a private group with access to a set of services at block 205. For example, a user device of a hotel guest checking into room 104a illustrated in FIG. 1 may send request from their user device to access an end device 112a, where the request includes a credential and the end device 112a is associated with multiple end devices registered to the private group UDN group 106a with access to a set of services 110a (e.g., services S1 and S2). According to some examples, the private group can be assigned or tagged as a dynamic UDN group. Member devices of the UDN group are configured to be appended or removed on an at-will basis.

According to some examples, the method can include tagging the UDN group with a UDN group ID. For example, UDN group 106a can be tagged with UDN-ID:1. The UDN group can be logically associated with multiple end devices within a room. For example, the end devices 112a illustrated in FIG. 1 may be multiple end devices logically associated with room 104a (e.g., by registering the end devices 112a to UDN group 106a). The multiple end devices 112a are unilateral devices that cannot communicate with devices outside UDN group 106a. In some embodiments, the number of member end devices 112a within UDN group 106a can be limited.

According to some examples, the method includes creating one or more policies associated with the private group. For example, services 110a illustrated in FIG. 1 are one or more policies associated with UDN group 106a. In some embodiments, two or more private groups are associated with a same physical space. For example, room 104a illustrated in FIG. 1 may contain two or more UDN groups within the same physical space.

According to some examples, the method includes dynamically adding a user device identity of the user device to the UDN group based on authenticating the user device. In some embodiment, authenticating the user device can be based on a credential being associated with the UDN group. For example, the user device may be assigned a room and password and/or other credentials. In some embodiments, a guest for a room is assigned to the UDN group by associating the user device with a specific access point device.

According to some examples, the method includes determining co-location of the user device to an access point. The ability of the user device to connect with the access point can validate the co-location of the user device to the room corresponding to the UDN group.

According to some examples, the method includes granting authorization to include the user device within the private group by adding it to the UDN group. For example, the UDN group 106a illustrated in FIG. 1 may append a user device and grant authorization to access the services and policies within the UDN group.

In some examples, the method includes a change of authorization to include the user device within the UDN group at block 255, which can be based on the co-location of the user device to the room corresponding to the UDN group. For example, once an access point detects the user device, that detection may trigger a change of authorization to include the user device within the UDN group.

According to some examples, the method includes restricting access of the user device to other private groups associated with locations outside of the UDN group. For access of the user device to other private groups associated with geolocations outside of the UDN group can be restricted. In some embodiments, if the access point loses communication with the user device, access to the UDN group can be revoked.

According to some examples, the method includes granting the user device access to the set of services. For example, the user device in room 104a illustrated in FIG. 1 may be granted access to the set of services 110a S1 and S2.

According to some examples, the method includes dynamically removing the user device from the UDN group based on removing the user device identity. A second user device identity of a second user device can be dynamically mapped to the UDN group, and a change of authorization to include the second user device within the UDN group can be sent to the controller.

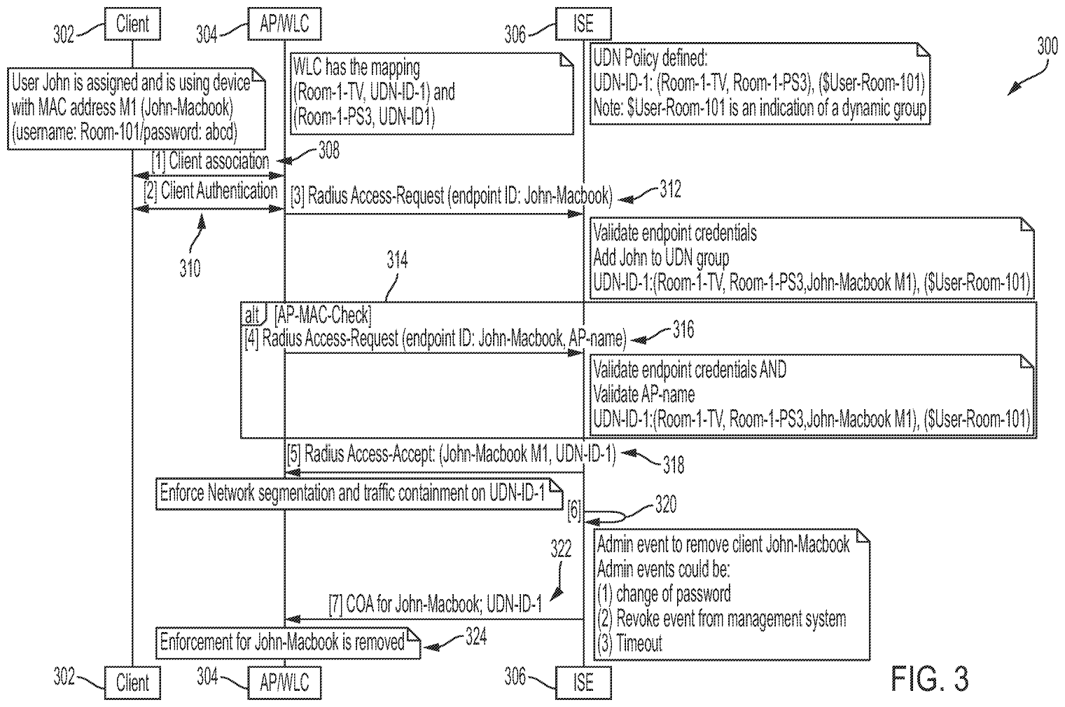

FIG. 3 illustrates an example communication diagram for implementing one or more UDNs within the same physical space, according to some aspects of the present disclosure. System 300 shows client 302, access point/Wireless LAN Controller (AP/WLC 304), and Identity Services Engine (ISE 306). In the example embodiment, WLC 304 is within Room 1 and has a mapping to a UDN with an identity of UDN-ID-1. WLC 304 has a mapping of UDN-ID-1 to a TV (Room-1-TV) and a PS3 (Room-1-PS3). The mapping can be defined as: (Room-1-TV, UDN-ID-1) and (Room-1-PS3, UDN-ID-1).

The ISE 306 has defined the UDN Policy (which may be one or more policies/services corresponding to the UDN group). For example, one policy may be that the UDN group is a dynamic group that appends and/or removes devices within the UDN group. The policy may be defined as UDN-ID-1: (Room-1-TV, Room-1-PS3), ($User-Room-101). The string $User-Room-101 may be a tag that indicates the UDN group is dynamic.

When user John checks into a room (and/or is assigned the room), client 302 can be a device John is using, such as (John-Macbook) with MAC address M1. John can be assigned username: “Room-101” with password “abcd”.

Client 302 can perform association 308 and then authentication 310 with AP/WLC 304. The AP/WLC 304 can send a Radius Access-Request 312 (with endpoint ID: John-Macbook) to ISE 306. The ISE 306 can validate the endpoint credentials (validates the device associated with John-Macbook) and then adds John's device to the UDN group. The policy is now defined as UDN-ID-1: (Room-1-TV, Room-1-PS3, John-Macbook M1), ($User-Room-101).

In some embodiments, an access point-user device check 314 can be performed by system 300, although this step can be optional in some embodiments. The AP/WLC 304 sends a Radius Access Request with the access point ID (endpoint ID: John-Macbook, AP-name). The ISE 306 validates the endpoint credentials and the access point name as well. Once AP-name has been validated as well, the policy is defined as UDN-ID-1: (Room-1-TV, Room-1-PS3, John-Macbook M1), ($User-Room-101).

The ISE 306 then sends a Radius Access Accept message 318 to AP/WLC 304. The AP/WLC 304 enforces network segmentation and traffic containment on UDN-ID-1 consistent with the UDN Policies.

After a period of time has elapsed, such as John checking out of the hotel, the ISE 306 creates an event to remove client 302 John-Macbook from UDN-ID-1. It does through various mechanisms, including but not limited to: a change of password, a revoke event from the management system, a timeout (e.g., length of time past the length of John's stay). The ISE 306 then send a change of authorization (COA 322) for John-Macbook for UDN-ID-1 to the AP/WLC 304. Client 302 John-Macbook is removed 324.

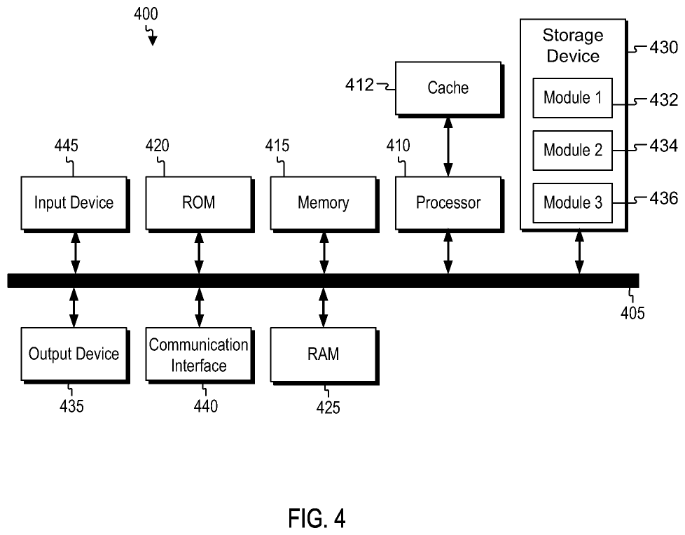

FIG. 4 shows an example of computing system 400, which can be for example any computing device making up [[insert reference to one or more devices discussed earlier in the disclosure]] or any component thereof in which the components of the system are in communication with each other using connection 405. Connection 405 can be a physical connection via a bus, or a direct connection into processor 410, such as in a chipset architecture. Connection 405 can also be a virtual connection, networked connection, or logical connection.

In some embodiments computing system 400 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 400 includes at least one processing unit (CPU or processor) 410 and connection 405 that couples various system components including system memory 415, such as read only memory (ROM) 420 and random access memory (RAM) 425 to processor 410. Computing system 400 can include a cache of high-speed memory 412 connected directly with, in close proximity to, or integrated as part of processor 410.

Processor 410 can include any general purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 445, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 440, which can generally govern and manage the user input and system output. There is no restriction on operating on any particular hardware arrangement and therefore the basic features here may easily be substituted for improved hardware or firmware arrangements as they are developed.

Storage device 430 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 430 can include software services, servers, services, etc., that when the code that defines such software is executed by the processor 410, it causes the system to perform a function. In some embodiments, a hardware service that performs a particular function can include the software component stored in a computer-readable medium in connection with the necessary hardware components, such as processor 410, connection 405, output device 435, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Aspect 1. A method comprising: receiving, from an application on a user device, a request from a user device to access an end device, wherein the request includes a credential and the end device is associated with multiple end devices within a private group with access to a set of services; from an application on a user device, a request from a user device to access an end device, wherein the request includes a credential and the end device is associated with multiple end devices within a private group with access to a set of services; dynamically adding a user device identity of the user device to the private group (UDN) based on authenticating the user device based on the credential being associated with the private group; sending, to a controller, a change of authorization to include the user device within the private group; and to a controller, a change of authorization to include the user device within the private group; and granting the user device access to the set of services.

Aspect 2. The method of Aspect 1, wherein the private group is logically associated with multiple end devices within a room. wherein the private group is logically associated with multiple end devices within a room.

Aspect 3. The method of any of Aspects 1 to 2, wherein two or more private groups are associated with a same physical space. wherein two or more private groups are associated with a same physical space.

Aspect 4. The method of any of Aspects 1 to 3, the method further comprising: the method further comprising: dynamically removing the user device from the private group based on removing the user device identity; dynamically mapping a second user device identity of a second user device to the private group; and sending, to the controller, a change of authorization to include the second user device within the private group. to the controller, a change of authorization to include the second user device within the private group.

Aspect 5. The method of any of Aspects 1 to 4, the method further comprising: the method further comprising: registering the multiple end devices to the private group; and in response to registering the multiple end devices, creating one or more policies associated with the private group.

Aspect 6. The method of any of Aspects 1 to 5, wherein the multiple end devices are unilateral devices that cannot communicate with devices outside the private group.

Aspect 7. The method of any of Aspects 1 to 6, wherein a guest for a room is assigned to the private group (UDN) by associating the user device with a specific access point device.

Aspect 8. The method of any of Aspects 1 to 7, the method further comprising: the method further comprising: determining co-location of the user device to an access point; validating the co-location of the user device to the private group based on the access point detection; sending, to the controller, a change of authorization to include the user device within the private group based on the co-location of the user device to the private group; and to the controller, a change of authorization to include the user device within the private group based on the co-location of the user device to the private group; and restricting access of the user device to other private groups associated with geolocations outside of the private group.

Aspect 9. The method of any of Aspects 1 to 8, the method further comprising: the method further comprising: assigning the private group to be a dynamic UDN group, wherein member devices of the UDN group are configured to be appended or removed on an at-will basis. E.g., tagging the UDN group ID.

Aspect 10. The method of any of Aspects 1 to 9, wherein the number of member devices within the private group is limited.

Aspect 11. The method of any of Aspects 1 to 10, wherein the user device is removed from the private group. wherein the user device is removed from the private group.

What is claimed is:

1. A method comprising:
receiving, from an application on a user device, a request from the user device to access an end device, wherein the request includes a credential and the end device is associated with multiple end devices within a private group with access to a set of services;
dynamically adding a user device identity of the user device to the private group (UDN) based on authenticating the user device based on the credential being associated with the private group;
sending, to a controller, a change of authorization to include the user device within the private group; and
granting the user device access to the set of services.

2. The method of claim 1, wherein the private group is logically associated with multiple end devices within a room.

3. The method of claim 1, wherein two or more private groups are associated with a same physical space.

4. The method of claim 1, the method further comprising:
dynamically removing the user device from the private group based on removing the user device identity;
dynamically mapping a second user device identity of a second user device to the private group; and
sending, to the controller, a change of authorization to include the second user device within the private group.

5. The method of claim 1, the method further comprising:
registering the multiple end devices to the private group; and
in response to registering the multiple end devices, creating one or more policies associated with the private group.

6. The method of claim 1, wherein the multiple end devices are unilateral devices that cannot communicate with devices outside the private group.

7. The method of claim 1, wherein a guest for a room is assigned to the private group (UDN) by associating the user device with a specific access point device.

8. The method of claim 1, the method further comprising:
determining co-location of the user device to an access point;
validating the co-location of the user device to the private group based on detecting the access point;
sending, to the controller, a change of authorization to include the user device within the private group based on the co-location of the user device to the private group; and
restricting access of the user device to other private groups associated with geolocations outside of the private group.

9. The method of claim 1, the method further comprising:
assigning the private group to be a dynamic UDN group, wherein member devices of the UDN group are configured to be appended or removed on an at-will basis.

10. The method of claim 1, wherein a number of member devices within the private group is limited.

11. The method of claim 1, wherein the user device is removed from the private group.

12. A computing apparatus comprising:
a processor; and
a memory storing instructions that, when executed by the processor, configure the apparatus to:
receive, from an application on a user device, a request from the user device to access an end device, wherein the request includes a credential and the end device is associated with multiple end devices within a private group with access to a set of services;
dynamically add a user device identity of the user device to the private group (UDN) based on authenticating the user device based on the credential being associated with the private group;
send, to a controller, a change of authorization to include the user device within the private group; and
grant the user device access to the set of services.

13. The computing apparatus of claim 12, wherein the private group is logically associated with multiple end devices within a room.

14. The computing apparatus of claim 12, wherein two or more private groups are associated with a same physical space.

15. The computing apparatus of claim 12, wherein the instructions further configure the apparatus to:
dynamically remove the user device from the private group based on removing the user device identity;
dynamically map a second user device identity of a second user device to the private group; and
send, to the controller, a change of authorization to include the second user device within the private group.

16. The computing apparatus of claim 12, wherein the instructions further configure the apparatus to:
register the multiple end devices to the private group; and
in response to registering the multiple end devices, create one or more policies associated with the private group.

17. A non-transitory computer-readable storage medium, the computer-readable storage medium including instructions that when executed by a computer, cause the computer to:
receive, from an application on a user device, a request from the user device to access an end device, wherein the request includes a credential and the end device is associated with multiple end devices within a private group with access to a set of services;
dynamically add a user device identity of the user device to the private group (UDN) based on authenticating the user device based on the credential being associated with the private group;
send, to a controller, a change of authorization to include the user device within the private group; and
grant the user device access to the set of services.

18. The computer-readable storage medium of claim 17, wherein the private group is logically associated with multiple end devices within a room.

19. The computer-readable storage medium of claim 17, wherein two or more private groups are associated with a same physical space.

20. The computer-readable storage medium of claim 17, wherein the instructions further configure the computer to:
dynamically remove the user device from the private group based on removing the user device identity;
dynamically map a second user device identity of a second user device to the private group; and
send, to the controller, a change of authorization to include the second user device within the private group.
